(19) United States
(12) Patent Application Publication
(10) Pub. No.: US 2018/0216532 A1
(43) Pub. Date: Aug. 2, 2018

(54) SYSTEM AND METHOD FOR TREATING EXHAUST GAS

(71) Applicant: General Electric Company, Schenectady, NY (US)

(72) Inventor: Gordon Raymond Smith, Schenectady, NY (US)

(21) Appl. No.: 15/421,325

(22) Filed: Jan. 31, 2017

(51) Int. Cl. F02C 7/10; F02C 6/18; F01N 3/10

(52) U.S. Cl. CPC F02C 7/10; F02C 6/18; F01N 2570/10; F01N 2610/01; F01N 3/10

(57) ABSTRACT

A gas turbine system includes an exhaust gas processing system that includes an exhaust stack having a first inlet and a first outlet. The first inlet is fluidly coupled to a second outlet of a cooler configured to direct the exhaust gas to the exhaust gas processing system via a first conduit extending between the exhaust stack and the cooler. The first conduit includes a first end configured to be directly coupled to the second outlet of the cooler and a second end configured to be directly coupled to the first inlet of the exhaust stack. The exhaust gas processing system also includes a carbon capture system disposed within the exhaust stack and configured to receive a carbon dioxide (CO₂) lean solvent, to remove CO₂ from the exhaust gas, to generate a CO₂-rich solvent comprising the CO₂ removed from the exhaust gas, and to generate a treated exhaust gas.

### BACKGROUND

The subject matter disclosed herein relates to gas turbine systems and, more specifically, to systems for treating exhaust gas produced by gas turbine systems.

Gas turbine systems typically include at least one gas turbine engine having a compressor, a combustor, and a turbine. The combustor combusts a mixture of fuel and compressed air to generate hot combustion gas, which, in turn, drives blades of the turbine. Exhaust gas produced by the gas turbine engine may include certain byproducts, such as carbon dioxide. In certain situations (e.g., driven by environmental regulations or other concerns), it is desirable to remove or substantially reduce the amount of such byproducts in the exhaust gas prior to releasing the exhaust gas from the gas turbine system. For example, the exhaust gas may be routed to a carbon capture plant coupled to the gas turbine system. The carbon capture plant may treat the exhaust gas and recover carbon dioxide from the exhaust gas. The exhaust gas may flow from a stack of the gas turbine system to a carbon capture stack of the carbon capture plant. Inside the carbon capture stack, carbon dioxide that may be present in the exhaust gas may be absorbed onto an absorption column, thus generating treated exhaust gas having substantially no carbon dioxide. However, carbon capture plants may use a large amount of real estate and additional equipment, which may increase the overall capital, operational, and maintenance costs of the gas turbine system compared to gas turbine systems that do not utilize carbon capture plants.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, a gas turbine system includes an exhaust gas processing system configured to receive an exhaust gas generated in a gas turbine engine. The exhaust gas processing system includes an exhaust stack having a first inlet and a first outlet. The first inlet is fluidly coupled to a second outlet of a cooler configured to direct the exhaust gas to the exhaust gas processing system via a first conduit extending between the exhaust stack and the cooler. The first conduit includes a first end configured to be directly coupled to the second outlet of the cooler and a second end configured to be directly coupled to the first inlet of the exhaust stack. Additionally, the cooler is configured to receive the exhaust gas from the gas turbine engine. The exhaust gas processing system also includes a carbon capture system disposed within the exhaust stack and configured to receive a carbon dioxide (CO₂) lean solvent, to remove CO₂ from the exhaust gas, to generate a CO₂-rich solvent comprising the CO₂ removed from the exhaust gas, and to generate a treated exhaust gas.

In a second embodiment, a gas turbine system includes a gas turbine engine configured to generate and exhaust gas and a cooler disposed downstream from the gas turbine engine. The cooler includes a first inlet and a first outlet. The first inlet of the cooler is configured to receive the exhaust gas from the gas turbine engine. The gas turbine system also includes an exhaust gas processing system fluidly coupled to the cooler. The exhaust gas processing system includes an exhaust stack having a second inlet and a second outlet. The second inlet is fluidly coupled to the first outlet of the cooler via a first conduit extending between the exhaust stack and the cooler and configured to direct the exhaust gas from the cooler to the exhaust stack. The first conduit includes a first end configured to be directly coupled to the first outlet of the cooler and a second end configured to be directly coupled to the second inlet of the exhaust stack. The exhaust processing system also includes a carbon capture system disposed within the exhaust stack and configured to receive a carbon dioxide (CO₂) lean solvent, to remove CO₂ from the exhaust gas, to generate a CO₂-rich solvent comprising the CO₂ removed from the exhaust gas, and to generate a treated exhaust gas.

In a third embodiment, a method includes generating an exhaust gas in a gas turbine engine disposed within a gas turbine system and directing the exhaust gas to a cooler fluidly coupled to the gas turbine engine to generate a cooled exhaust gas. The method also includes supplying the cooled exhaust gas from the cooler to an exhaust gas processing system via a conduit having a first end and a second end. The first end is configured to be directly coupled to an outlet of the cooler and the second end is configured to be directly coupled to an inlet of the exhaust gas processing system. Additionally, the exhaust gas processing system includes a carbon capture system disposed within an exhaust stack of the gas turbine system. The method further includes removing carbon dioxide (CO₂) from the exhaust gas within the carbon capture system to generate a treated exhaust gas and a CO₂-rich solvent. The method additionally includes treating the CO₂-rich solvent in a regeneration system fluidly coupled to the carbon capture system to recover CO₂ from the CO₂-rich solvent and to generate a CO₂-lean solvent. The regeneration system is configured to supply the CO₂-lean solvent to the carbon capture system.

### BRIEF DESCRIPTION

These and other features, aspects, and advantages of the present disclosure will become better understood when the following detailed description is read with reference to the accompanying drawings in which like characters represent like parts throughout the drawings, wherein:

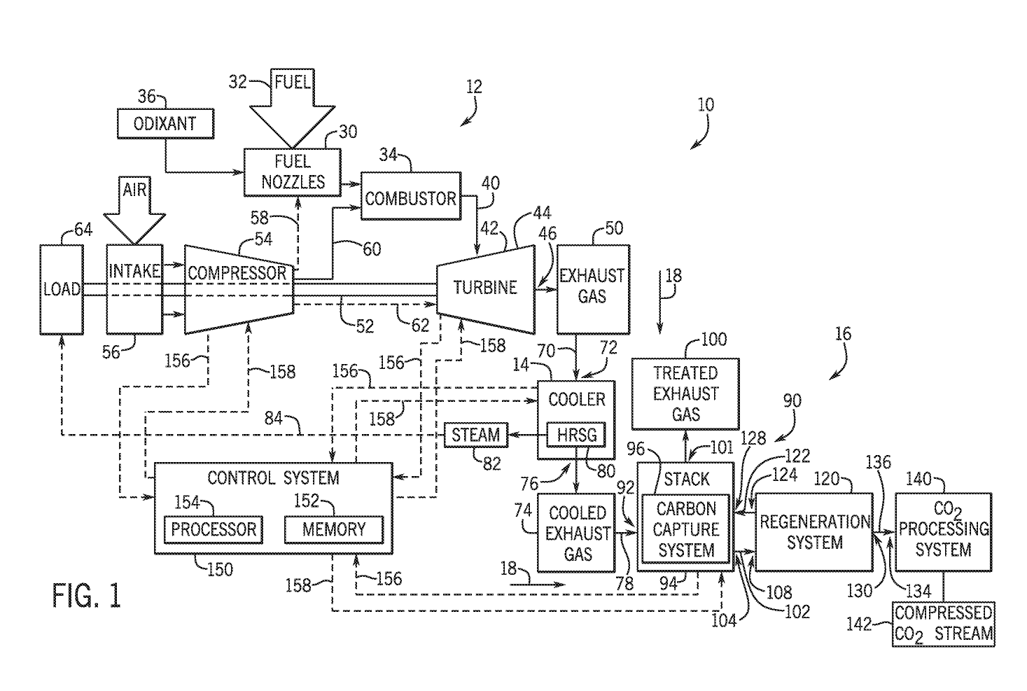

FIG. 1 is a block diagram of a gas turbine system having an exhaust processing system, whereby the exhaust processing system receives and treats an exhaust gas generated in the gas turbine system, in accordance with an embodiment of the present disclosure;

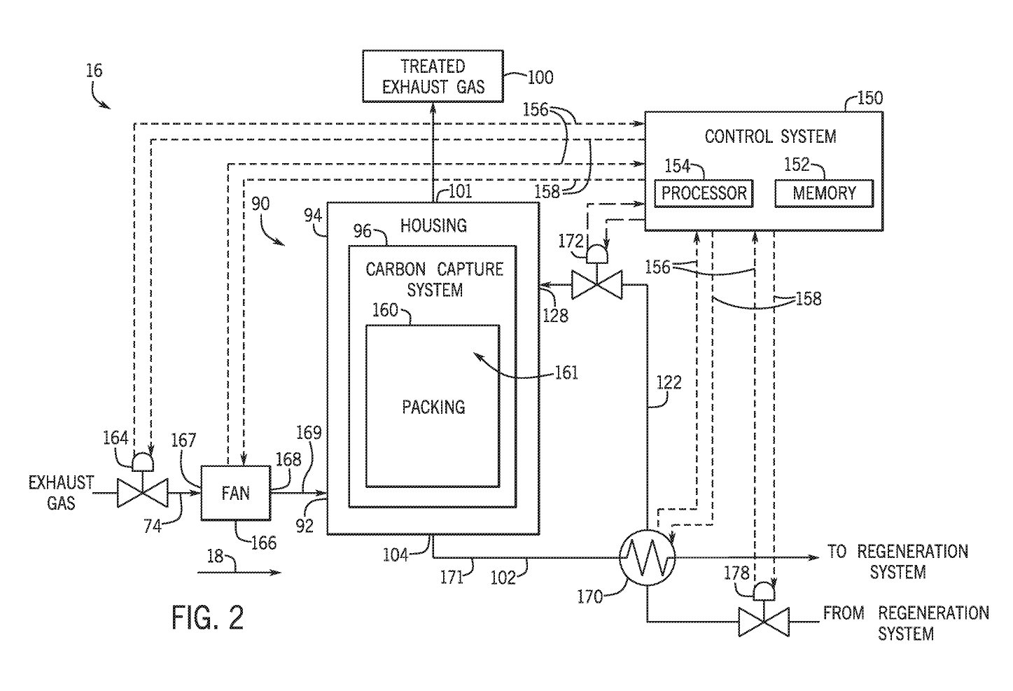

FIG. 2 is a block diagram of the exhaust processing system of FIG. 1, whereby the exhaust processing system includes a stack, in accordance with an embodiment of the present disclosure;

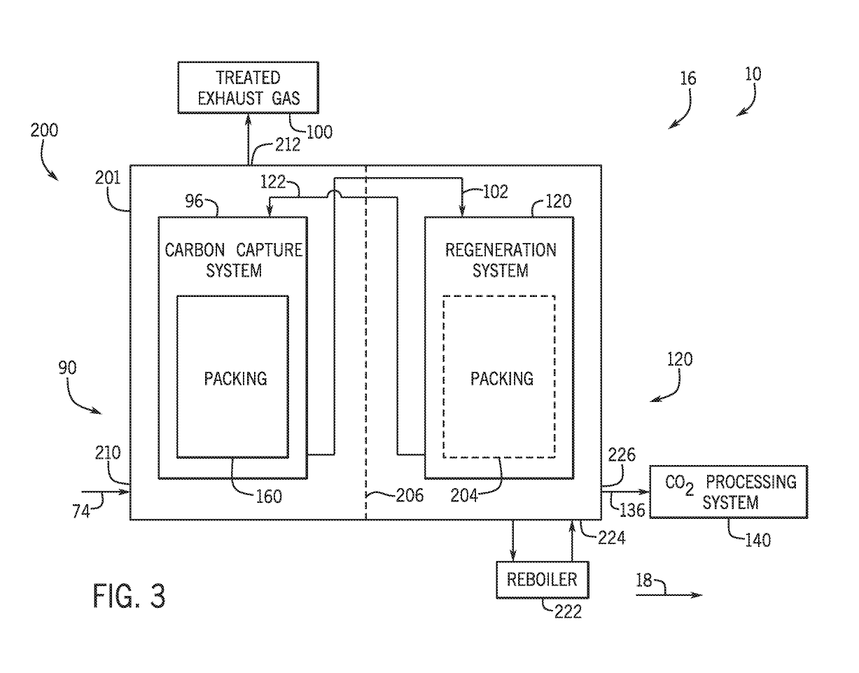

FIG. 3 is a block diagram of the exhaust processing system of FIG. 1, whereby the exhaust processing system includes an exhaust processing system and a regeneration system, in accordance with an embodiment of the present disclosure; and

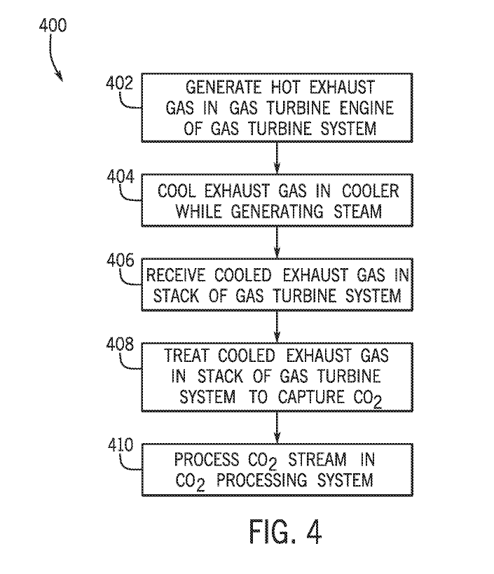

FIG. 4 is a flow diagram of a method for treating the exhaust gas using the system of FIG. 1, in accordance with an embodiment of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Embodiments disclosed herein generally relate to techniques for treating exhaust gas generated by a gas turbine engine. In general, the exhaust gas from the gas turbine engine is routed to a carbon capture plant. For example, certain gas turbine engines may include an exhaust stack that is blocked off (e.g., retroactively) so that exhaust gas is routed to the carbon capture plant. However, the gas turbine systems coupled to carbon capture plants may have increased capital, operational, and maintenance costs associated with directing the exhaust gas to a separate carbon capture plant. It is now recognized that by integrating (e.g., combining) certain features of the carbon capture plant (e.g., exhaust gas cooling, carbon capture system) into the exhaust stack of the turbine system, capital, operational, and maintenance costs associated with a gas turbine system may be decreased.

In the gas turbine system, one or more gas turbine engines may combust a mixture of fuel and air to produce combustion gas for driving one or more turbines. Depending on the type of fuel that is combusted, emissions (e.g., exhaust gas) resulting from the combustion process may include nitrogen oxides (NOₓ), sulfur oxides (SOₓ), unburned hydrocarbons, and/or carbon dioxide. It may be desirable to capture the carbon dioxide from the exhaust gas exiting the gas turbine system, such as a gas turbine power generation plant, while also maintaining efficient operation and low costs of the gas turbine system.

By combining (e.g., integrating) the exhaust processing system within the gas turbine system, operation efficiency of the gas turbine system may be increased, while capital, operational, and maintenance costs may be lowered compared to systems having separate facilities for energy generation and carbon capture. As discussed herein, the gas turbine system disclosed herein may include an exhaust processing system disposed within a stack of the gas turbine system that treats the exhaust gas, rather than routing the exhaust gas to a separate carbon capture plant. That is, the exhaust processing system is in fluid communication with the exhaust gas of the gas turbine engine, without an existing exhaust stack positioned between the exhaust gas processing system and the gas turbine engine. Accordingly, present embodiments include a gas turbine system, such as a combined cycle heavy-duty gas turbine system having an exhaust processing system, to treat exhaust gas and capture carbon (e.g., carbon dioxide) from the exhaust gas. Further, while the disclosed embodiments may be particularly useful in combined cycle heavy-duty gas turbine systems, as will be discussed below, it should be understood that the present embodiments may be implemented in any suitably configured system, including simple cycle gas turbine systems, or reciprocating engines, for example.

With the foregoing in mind, FIG. 1 is a block diagram of an embodiment of a gas turbine system 10 that includes a gas turbine engine 12, a cooler 14, and an exhaust processing system 16. In certain embodiments, the gas turbine system 10 may be part of a power generation system. In the illustrated embodiment, the gas turbine system 10 is depicted as a combined cycle gas turbine system (e.g., includes a heat recovery steam generator, as discussed below). However, in other embodiments, the gas turbine system 10 may be a simple cycle gas turbine system. The gas turbine system 10 may use liquid or gas fuel, such as natural gas and/or a hydrogen rich synthetic gas, to drive the gas turbine system 10. As noted herein, a downstream direction 18 extends along a flow path of exhaust gas and/or carbon dioxide (CO₂) through the gas turbine system 10.

The exhaust processing system 16 disclosed herein may be more compact and efficient for capturing CO₂ compared to systems having a separate gas turbine system and carbon capture system. For example, in the gas turbine system, the exhaust stack is generally a hollow column that receives the exhaust gas and directs the exhaust gas to the carbon capture system or releases the exhaust gas from the exhaust stack. It is now recognized that the space within the exhaust stack may be utilized to include certain features of the carbon capture system. As discussed herein, the exhaust stack is designed to function as an absorption stack having a carbon capture system. More particularly, it is now recognized that by using the space available in the exhaust stack of the gas turbine engine that would otherwise not be utilized, to include portions of the carbon capture system, carbon capture plants generally associated with gas turbine engines may be replaced with integrated exhaust processing systems reduced in cost, complexity, and size. As such, the gas turbine system disclosed herein may use a smaller amount of real estate (e.g., space). Accordingly, gas turbine engines that include the exhaust processing system 16 may have decreased capital, operational, and maintenance costs.

In the illustrated embodiment, the gas turbine engine 12 receives a fuel 32 via fuel nozzles 30 that direct the fuel 32 into a combustor 34 of the gas turbine engine 12. The fuel nozzles 30 may mix the fuel with an oxidant 36, such as air, oxygen, oxygen-enriched air, oxygen reduced air, or any other suitable oxidant and combinations thereof. The fuel nozzles 30 may mix the fuel 32 and the oxidant 36 such that a ratio of fuel to oxidant is suitable for combustion (i.e., to achieve a desirable power output and emissions). The fuel-oxidant mixture combusts in a chamber within the combustor 34, thereby creating exhaust gas 40 (e.g., hot exhaust gas). In certain embodiments, the exhaust gas 40 includes certain combustion byproducts (e.g. CO₂) that may be removed in the exhaust processing system 16.

The combustor 34 directs the exhaust gas 40 into a turbine nozzle (or “stage one nozzle”), causing rotation of a turbine 42 within a turbine casing 44 (e.g., outer casing). The exhaust gas 40 flows toward an exhaust outlet 46 of the turbine 42. As the exhaust gas 40 flows through and exits the turbine 42 (e.g., as exhaust gas 50), the exhaust gas 40 forces turbine buckets (or blades) to rotate a shaft 52 along an axis of the gas turbine system 10. The exhaust gas 50 exiting the turbine 42 flows out through the exhaust outlet 46 and in the downstream direction 18 toward the cooler 14.

The shaft 52 may be connected to various components of the gas turbine system 10, including a compressor 54. Similar to the turbine 42, the compressor 54 also includes blades coupled to the shaft 52. As the shaft 52 rotates, the blades within the compressor 54 rotate, thereby compressing air from an air intake 56 through the compressor 54 and into the fuel nozzles 30 as shown by arrow 58 and/or into the combustor 34 as shown by arrow 60. A portion of the compressed air (e.g., discharged air) from the compressor 54 may be diverted to the turbine 42 or its components without passing through the combustor 34, as shown by arrow 62. The discharged air 62 (e.g., cooling fluid) may be utilized to cool turbine components such as shrouds and nozzles on a stator of the turbine 42, along with buckets, disks, and spacers on a rotor of the turbine 42. The shaft 52 may also be connected to a load 64, which may be a vehicle, a ship, a stationary load, such as an electrical generator in a power plant or a propeller on an aircraft, or any other suitable device that may be powered by the rotational output of the gas turbine system 10.

As discussed above, the exhaust gas 40 enters the turbine 42 and spins the turbine 42 within the turbine casing 44. In this manner, the exhaust gas 40 transfers mechanical energy to the turbine 42, which generates the exhaust gas 50 (e.g., low-pressure, hot exhaust gas). The exhaust gas 50 exits the turbine 42 and flows in the downstream direction 18 through a conduit 70, extending between the exhaust outlet 46 and an inlet 72 of the cooler 14.

It is now recognized that cooling of the exhaust gas 50 may be completed by a cooler of the gas turbine system, without first sending the exhaust gas 50 to a separate carbon capture plant. For example, the cooler 14 receives the exhaust gas 50 through the inlet 72, cools the exhaust gas 50, and releases cooled exhaust gas 74 through an outlet 76 of the cooler 14. The cooler 14 may be disposed between the gas turbine engine 12 and the exhaust processing system 16. The cooler 14 may provide cooling to facilitate treatment of the exhaust gas 74 (e.g., recovery of the CO₂ within the exhaust gas 74) within the gas turbine system 10. For example, the cooler 14 may decrease the temperature of the exhaust gas 50 to generate the cooled exhaust gas 74. The cooled exhaust gas 74 may be cooled to a temperature that is suitable for recovery of the CO₂ of the cooled exhaust gas 74 via the exhaust processing system 16. The temperature of the cooled exhaust gas 74 may be such that the exhaust processing system 16 may operate more efficiently, processes (e.g., absorption processes) used to recover CO₂ from the exhaust gas within the exhaust processing system 16 may be optimized, and/or thermal degradation of system components within the exhaust processing system 16 that may be caused by elevated temperatures of the exhaust gas may be mitigated. To mitigate degradation of the exhaust processing system 16 that may be caused by byproducts within the exhaust gas 50 (e.g., generated during combustion), the cooler 14 may condition the exhaust gas 50. For example, the cooler 14 may include one or more scrubbers designed to remove (e.g., separate) byproducts (e.g., SOₓ, NOₓ, unburned fuel 32, entrained solids) from the exhaust gas 50 that may be generated during combustion in the gas turbine engine 12.

As discussed above, a temperature of the cooled exhaust gas 74 may be lower than a temperature of the exhaust gas 50 after the exhaust gas travels through the cooler 14. In particular, a certain threshold of cooling may be required before the exhaust gas (e.g., cooled exhaust gas 74) may flow into the exhaust processing system 16. Additionally, the cooled exhaust gas 74 may be at a temperature in a range suitable for the CO₂ absorption process to proceed. In certain embodiments, the cooled exhaust gas 74 may be cooled below a threshold temperature (e.g., temperature at which the exhaust processing system 16 operates efficiently, desired temperature, preset temperature) such as 30, 50, 70, 90, or 110 degrees Celsius, or any other threshold temperature suitable for the exhaust processing system 16 to operate.

There may be a variety of components included within the cooler 14 that may facilitate cooling the exhaust gas 50. For example, in certain embodiments, the cooler 14 may include a direct contact water cooler (DCC). The DCC may remove water from the cooled exhaust gas 74, thus lessening corrosion of system components within the gas turbine system 10 by substantially removing the water before the water contacts metal downstream components of the gas turbine system 10. The cooler 14 may include cooling coils that receive a cooling fluid (e.g., water) that extracts heat from the exhaust gas 50. Indeed, the cooler 14 may be of any type of cooler suitable for cooling the exhaust gas 50 to a temperature suitable for processing the exhaust gas in the exhaust processing system 16. In certain embodiments, the cooled exhaust gas 74 may bypass the cooler 14 and flow directly into a stack 90.

In certain embodiments, the cooler 14 includes a heat recovery steam generator (HRSG) 80. The HRSG 80 may recover a portion of the thermal energy of the exhaust gas 50 to heat a fluid (e.g., water) and generate steam 82. The HRSG 80 may direct the steam 82 to a steam turbine system (not shown), which may drive a load (e.g., an electrical generator). In some embodiments, the steam 82 may flow along a conduit 84 to drive the load 64 of the gas turbine engine 12. The HRSG 80 may increase the power production of the gas turbine system 10 while also recovering thermal energy from the exhaust gas 50. The HRSG 80 may additionally include extra cooling components (e.g., cooling coils, heat exchangers) to provide additional reduction of the temperature of the exhaust gas 50. In embodiments where the gas turbine system is a simple cycle gas turbine system, the HRSG 80 may be omitted. Additionally, in certain embodiments, the HRSG 80 may be external to the cooler 14. In such embodiments, the exhaust gas 50 may be directed to the cooler 14 along a conduit extending from the HRSG 80 to the cooler 14, and cooled to generate cooled exhaust gas 74, which is directed to the stack 90.

Further, the heat removed from the exhaust gas 50 by the cooler 14 may be used by other components of the gas turbine system 10. For example, a regeneration system 120 of the gas turbine system 10 may use the heat removed from the exhaust gas 50. In such embodiments, a reboiler or heater of the regeneration system 120 may be combined with the cooler 14. Additionally, the heat removed from the exhaust gas 50 may be used to reduce icing in the compressor. Indeed, while only two examples are provided above, it is to be understood that the heat removed from the exhaust gas 50 may be used by any suitable component for saving energy and increasing efficiency in the gas turbine system 10.

As discussed above, the gas turbine system 10 includes the exhaust processing system 16 that may treat the cooled exhaust gas 74 to remove certain combustion byproducts and/or capture CO₂. The exhaust processing system 16 may reduce and recover an amount of combustion by-products that are present in the cooled exhaust gas 74. In contrast to certain gas turbine systems, the gas turbine system 10 disclosed herein is combined (e.g., integrated) with the exhaust processing system 16. That is, the exhaust gas processing system 16 is disposed within the gas turbine system 10 rather than in a carbon capture plant, which is generally separate from certain gas turbine systems. In the certain gas turbine systems, the hollow exhaust stack includes unused space that may be utilized to include certain components of the exhaust processing system. It is now recognized that by incorporating the exhaust gas processing system 16 within a stack of the gas turbine system 10, the overall costs associated with building a carbon capture plant may be decreased compared to a gas turbine system that routes and/or delivers the exhaust gas to a carbon capture plant adjacent the gas turbine system.

The exhaust processing system 16 may include certain features that facilitate removal and recovery of carbon dioxide (CO₂) from the cooled exhaust gas 74. As discussed above, the exhaust processing system 16 is incorporated into a stack 90 of the gas turbine system 10. In certain embodiments, the gas turbine system 10 may also include the regeneration system 120 and/or a carbon processing system 140. As discussed in further detail below, the regeneration system 120 may regenerate absorption solvents to collect CO₂ and the carbon processing system 140 may compress and dry the CO₂. As discussed above, heat utilized for regenerating the absorption solvents may be supplied to the regeneration system 120 from the cooler 14, the HRSG 80, a reboiler, or any other suitable device that may provide heat to the regeneration system 120.

Following cooling of the exhaust gas 50 in the HRSG 80, the cooled exhaust gas 74 may be fed to the stack 90, where the exhaust gas is treated and CO₂ is recovered from the cooled exhaust gas 74. In this way, the exhaust gas 74 may not be routed to a separate carbon capture plant that is generally used to recover the CO₂ from exhaust gas generated within the gas turbine system and release treated exhaust gas from the gas turbine system. For example, in certain gas turbine systems, the exhaust gas flows into a hollow stack fluidly coupled to a cooler (HRSG). The hollow stack may release the exhaust gas from the gas turbine system or direct the exhaust gas to a carbon capture plant (e.g., via a conduit that couples the hollow stack to the carbon capture plant). The carbon capture plant may include a column or separate stack that receives the exhaust gas, captures CO₂ from the exhaust gas, and releases the exhaust gas from the carbon capture plant. However, the carbon capture plant may utilize a large amount of space that may not be available near the gas turbine system, in addition to additional system components. As such, the overall capital, operational, and maintenance costs associated with the gas turbine system and the carbon capture plant may be increased compared to gas turbine systems that are not coupled to a carbon capture plant, such as the gas turbine system 10 disclosed herein. As discussed above, the gas turbine system 10 includes the exhaust processing system within the stack 90 (e.g., an exhaust stack) fluidly coupled to the cooler 14. For example, the outlet 76 of the cooler 14 may be directly to the stack 90, which includes the exhaust gas processing system 16 for treatment of the exhaust gas.

The stack 90 may include features that facilitate absorption and recovery of the CO₂ within the cooled exhaust gas 74. For example, the stack 90 includes a housing 94 that includes a carbon capture system 96. The housing 94 of the stack 90 may be made of refractory materials suitable for receiving exhaust gas. The housing 94 may enclose (e.g., circumferentially surround) the carbon capture system 96. The carbon capture system 96 may include absorption solvents, trays, and/or packing to facilitate treatment of the exhaust gas. For example, the carbon capture system 96 includes CO₂-lean absorption solvent that absorbs the CO₂ to generate rich absorption solvent and to generate a treated exhaust gas 100. The treated exhaust gas 100 may have a reduced CO₂ content and may be released from the gas turbine system 10 via an exhaust outlet 101. The carbon capture system 96 may include packing supported by trays that increase the surface area for CO₂ absorption processes, as described in detail below with reference to FIG. 2. While the embodiments disclosed herein are discussed in the concept of CO₂ absorption process, other carbon capture techniques may also be used. For example, the carbon capture techniques may include membrane filtration, adsorption/desorption, cryogenic separation, or other post-combustion carbon capture techniques.

As discussed above, the CO₂ may be absorbed into the CO₂-lean absorption solvent in the carbon capture system 96 to generate CO₂-rich absorption solvent. Following absorption of the CO₂, the CO₂-rich absorption solvent may flow into the regeneration system 120. The regeneration system 120 may remove the CO₂ from the CO₂-rich absorption solvent to generate the CO₂-lean absorption solvent. For example, within the regeneration system 120, the CO₂-rich absorption solvent may be heated to a high temperature (e.g., a temperature greater than or equal to the temperature at which the CO₂ desorbs from the absorption solvent) to promote separation of the CO₂ from the CO₂ absorption solvent, thereby generating the CO₂-lean absorption solvent. The CO₂ separated from the rich absorption solvent flow to the carbon processing system 140, where the CO₂ is to be dried and pressurized. A CO₂-lean absorption solvent stream 122 flows from a CO₂-lean chemical outlet 124 of the regeneration system 120 into the stack 90 via a conduit extending between the CO₂-lean chemical outlet 124 and a CO₂-lean chemical inlet 128 of the stack 90. By way of non-limiting example, the CO₂-lean absorption solvent stream 122 may include monoethanolamine [MEA], diglycolamine [DGA], diethanolamine [DEA], diisopropanolamine [DIPA], methyldiethanolamine [MDEA], or any other suitable solvent that absorbs CO₂.

In operation of the gas turbine system 10, the cooled exhaust gas 74 is diverted to the stack 90, where the exhaust gas interacts with the CO₂-lean absorption solvent stream 122. For example, following cooling and/or conditioning of the exhaust gas stream 50 in the cooler 14, the cooled exhaust gas 74 flows from a cooler outlet 76 and is directed to the stack 90 via a conduit 78 extending between the cooler outlet 76 and an exhaust inlet 92 of the stack 90. In this manner, the cooled exhaust gas 74 may flow in the downstream direction 18 and directly into the stack 90 where CO₂ is removed from the exhaust gas by absorption via the CO₂-lean absorption solvent stream 122. For example, the cooled exhaust gas 74 may flow upward through the stack 90, while the CO₂-lean absorption solvent stream 122 may flow downward (e.g., in a direction substantially opposite a flow direction of the exhaust gas through the stack 90) through the stack 90. That is, the CO₂-lean absorption solvent stream 122 and the cooled exhaust gas 74 flow countercurrent to each other. As discussed above, the cooled exhaust gas 74 may be CO₂-rich. Therefore, when the CO₂-lean absorption solvent stream 122 and the CO₂-rich cooled exhaust gas 74 are in contact, a substantial portion of the CO₂ in the cooled exhaust gas 74 may be absorbed into the CO₂-lean absorption solvent stream 122 to generate a CO₂-rich absorption solvent stream 102. The CO₂ may enter the bulk of the liquid of the CO₂-lean absorption solvent stream 122, thus generating the CO₂-rich absorption solvent stream 102. In this way, the CO₂ is removed (e.g., stripped) from the cooled exhaust gas 74. Additionally, the CO₂-rich absorption solvent stream 102 exits the stack 90 via CO₂-rich chemical outlet 104 and flows into the regeneration system 120 via a conduit extending between the CO₂-rich chemical outlet 104 and a CO₂-rich chemical inlet 108 of the regeneration system 120.

The regeneration system 120 may include features that may remove CO₂ from the CO₂-rich absorption solvent stream 102 to regenerate the CO₂-lean absorption solvent stream 122. For example, the regeneration system 120 may include a stack, the absorption solvents, and trays. Indeed, in certain embodiments, the regeneration system 120 may include a packed column; however, it is to be understood that in certain embodiments, other components that heat the CO₂-rich absorption solvent stream 102 and capture the released CO₂ may be included in the regeneration system 120. The CO₂-rich absorption solvent stream 102 may flow into the top of the regeneration system 120. In certain embodiments, the CO₂-rich absorption solvent stream 102 flows down through packing supported by the trays 123. A reboiler disposed proximate to and fluidly coupled to the regeneration system 120 may provide hot vapor (e.g., steam) that flows upward in the regeneration system 120 to be in countercurrent flow with the CO₂-rich absorption solvent stream 102. In certain embodiments, the hot vapor is heated and/or generated via heat removed from the exhaust gas 50 in the cooler 14. The hot vapor heats the CO₂-rich absorption solvent stream 102, causing the CO₂ to separate from the CO₂-rich absorption solvent stream 102. The regeneration system 120 may operate at a temperature greater than or equal to the temperature at which the CO₂ desorbs from the absorption solvent, to promote the separation of CO₂ from the CO₂-rich absorption solvent stream 102. In some embodiments, at least a portion of the CO₂ absorbed into the CO₂-rich absorption solvent stream 102 may desorb from the CO₂-rich absorption solvent stream 102 to generate the CO₂-lean absorption solvent stream 122. The CO₂-lean absorption solvent may have a reduced CO₂ content compared to the CO₂-rich absorption solvent stream 102. The CO₂-lean absorption solvent stream 122 may be recycled to the stack 90 though the CO₂-lean chemical inlet 128 to remove CO₂ from the exhaust gas, as discussed above.

The hot vapor that flows in to the regeneration system 120 from the bottom of the regeneration system 120 may carry the CO₂ released from the CO₂-rich absorption solvent stream 102 to form a CO₂ stream 136. The CO₂ stream 136 may flow downstream (e.g., in the direction 18) to the CO₂ processing system 140. In certain embodiments, the CO₂ stream 136 exits the regeneration system 120 via CO₂ outlet 130 and flows into the CO₂ processing system 140 via a conduit extending between the CO₂ outlet 130 and an inlet 134 of the CO₂ processing system 140. Inside the CO₂ processing system 140, the CO₂ stream 136 is compressed and dried. In some embodiments, the compression may be performed by compressors, and the drying may be performed by glycol drying units. It may be desirable to dry (e.g., remove steam and/or water) from the CO₂ stream 136 to mitigate degradation of downstream system components that may be caused by moisture in the CO₂ stream 136 (e.g., oxidation). In certain embodiments, additional compressing of the CO₂ stream 136 may be completed after the CO₂ stream 136 is dried to generate a compressed CO₂ stream 142. The compressed CO₂ stream 142 may be compressed to a pressure that is sufficient to flow the compressed CO₂ stream 142 to a desired location (e.g., oil and natural gas recovery facilities, food and beverage facilities, or sequestration sites for the CO₂). Accordingly, the compressed and dried CO₂ may be used in further applications. For example, the CO₂ may be used for enhanced oil and natural gas recovery, food and beverage industries, or sequestration of the CO₂.

As discussed above, when the CO₂-lean absorption solvent stream 122 flows through the stack 90, all or a part of the CO₂ in the cooled exhaust gas stream 74 may be absorbed into the absorption solvent to generate treated exhaust gas 100. The treated exhaust gas 100 may be released from the gas turbine system 10 through an exhaust outlet 101 of the stack 90. The treated exhaust gas 100 generated within the exhaust processing system 16 may have a CO₂ content that meets standards set forth by regulatory agencies. For example, the treated exhaust gas 100 may have a CO₂ content between 0% CO₂ and 5% CO₂.

The gas turbine system 10 may also include a control system 150 (e.g., an electronic and/or processor-based controller) to govern operation of the gas turbine system 10. The control system 150 may independently control operation of the gas turbine system 10 by electrically communicating with sensors, control valves, and pumps, or other flow adjusting features throughout the gas turbine system 10. The control system 150 may include a distributed control system (DCS) or any computer-based workstation that is fully or partially automated. For example, the control system 150 can be any device employing a general purpose or an application-specific processor 152, both of which may generally include memory 154 (e.g., memory circuitry) for storing instructions. The processor 152 may include one or more processing devices, and the memory 154 may include one or more tangible, non-transitory, machine-readable media collectively storing instructions executable by the processor 152 to control the gas turbine system 10, as discussed below, and control actions described herein. More specifically, the control system 150 receives input signals 156 from various components of the gas turbine system 10 and outputs control signals 158 to control and communicate with various components in the gas turbine system 10 in order to control the flow rates, motor speeds, valve positions, and emissions, among others, of the gas turbine system 10. As illustrated, the control system 150 is in communication with the gas turbine engine 12, the cooler 14, and/or the exhaust processing system 16. The control system 150 may communicate with control elements of the gas turbine engine 12, the cooler 14, and/or the exhaust processing system 16. The control system 150 may adjust combustion parameters, adjust flows of the fluids throughout the system, adjust operation of the exhaust processing system 16, and so forth.

Although the control system 150 has been described as having the processor 152 and the memory 154, it should be noted that the control system 150 may include a number of other computer system components to enable the control system 150 to control the operations of the gas turbine system 10 and the related components. For example, the control system 150 may include a communication component that enables the control system 150 to communicate with other computing systems. The control system 150 may also include an input/output component that enables the control system 150 to interface with users via a graphical user interface or the like.

FIG. 2 is a block diagram of an embodiment of the stack 90 of the exhaust processing system 16. The stack 90 utilizes the space inside the hollow stack of certain gas turbine systems to include certain components of a traditional carbon capture plant, such as the exhaust gas processing system 16. The stack 90 includes the exhaust gas processing system 16 having the carbon capture system 96 (e.g., or portions thereof) having packing 160. In certain embodiments, the packing 160 may be supported by trays.

As discussed above with reference to FIG. 1, the cooled exhaust gas 74 may exit the cooler 14 and flow into the stack 90 to be treated and/or released from the gas turbine system 10. A first flow valve 164 may receive output signals 156 from the control system 150 to control a flow of the exhaust gas entering the stack 90. The first flow valve 164 may also transmit input signals 158 indicative of a position of the first flow valve 164 to the control system 150. For example, the control system 150 may open the first flow valve 164 to allow the cooled exhaust gas 74 to flow into the stack 90. The control system 150 may also close the first flow valve 164 to block a flow of the exhaust gas into the stack 90.

In certain embodiments, a fan 166 may be positioned between the valve 164 and the stack 90 to motivate a flow of the exhaust gas through conduit 169 and into the stack 90. The fan 166 may increase a pressure of the cooled exhaust gas 74 on a discharge side of the fan 166 and decrease pressure on an inlet side of the fan 166 to motivate the exhaust gas through downstream components of the exhaust processing system 16. Performance of the gas turbine system 10 may be improved and/or maintained by maintaining the cooled exhaust gas 74 at a pressure equal to a theoretical (e.g., calculated, predetermined) pressure of the exhaust gas 74 without a carbon capture system 96. That is, by maintaining the pressure of the cooled exhaust gas 74 to the pressure at which exhaust gas may be released from a gas turbine system without an exhaust processing system 16, the fan 166 may perform less work. The fan 166 may overcome pressure losses associated with components of the gas turbine system and/or downstream components. In particular, it may be desirable to maintain a target pressure in the exhaust gas to maintain system efficiency at a desired level. The control system 150 may control a speed of the fan 166 such that the cooled exhaust gas 74 may reach a desired pressure to maintain flow of the exhaust gas through the gas turbine system 10. The gas turbine system 10 may include one or more pressure sensors disposed along the flow path of the exhaust gas that may provide signals indicative of a pressure of the cooled exhaust gas 76 at a specific location (e.g. upstream of the fan 166, downstream of the fan 166, inside the housing 94, among others). Based on the pressure of the exhaust gas, the control system 150 may adjust, activate, or deactivate the fan 166 via input signals 156 and output signals 158 accordingly.

The gas turbine system may use any suitable quantity of fans to increase the pressure of the cooled exhaust gas 74. In certain embodiments, the fan 166 may be disposed between the outlet 76 of the cooler 14 and the exhaust inlet 92 of the stack 90. Additional fans 166 may be disposed along the flow path of the cooled exhaust gas 74 at alternative locations at which increasing the pressure is desirable. For example, additional fans may be disposed along conduit 70 between the turbine 42 and the cooler 14. In some embodiments, the fan 166 may be omitted. In these embodiments, the pressure of the cooled exhaust gas 74 may be sufficient to overcome pressure drops that may occur within the gas turbine system 10.

As discussed above, the cooled exhaust gas 74 flows into the stack 90, where CO₂ is removed from the cooled exhaust gas 74. While in the stack 90, the cooled exhaust gas 74 may increase in thermal energy via the exothermic absorption processes, flow upward through the packing 160, and exit the stack 90 through an exhaust outlet 101 disposed at a top portion 95 of the housing 94. As the cooled exhaust gas 74 contacts the CO₂-lean absorption solvent stream 122, the treated exhaust gas 100 may be formed. The treated exhaust gas 100 may then flow from the exhaust outlet 101 of the stack 90 and be released from the gas turbine system 10. As discussed above, the treated exhaust gas 100 may have a CO₂ content that is less than approximately 5%. As disclosed herein, the gas turbine system 10 includes an integrated exhaust treatment system 16 that includes a carbon capture system 96 disposed within the stack 90 directly coupled to the cooler 14. In this way, the space within the stack 90 may be utilized for carbon capture, compared a gas turbine system that has a hollow stack.

The carbon capture system 96 within the stack 90 receives the CO₂-lean absorption solvent stream 122 from the regeneration system 120 to remove CO₂ from the cooled exhaust gas 74. In certain embodiments, the CO₂-lean absorption solvent stream 122 may flow through a heat exchanger 170 disposed along the flow path 171 extending between the regeneration system 120 and the stack 90. The heat exchanger 170 may be heat the CO₂-rich absorption solvent stream 122 using the CO₂-lean absorption solvent stream 102. For example, in some embodiments, it may be desirable for the CO₂-rich absorption solvent stream 102 to be heated to facilitate desorption of the CO₂. The heat exchanger 170 may be any suitable heat exchanger such as shell and tube heat exchangers, plate heat exchangers, fin type heat exchangers, tubular heat exchangers, and/or adiabatic wheel heat exchanger, or any other heat exchanger that transfers heat between one or more streams of fluids.

The CO₂-lean absorption solvent stream 122 may flow from the heat exchanger 170 to a CO₂-lean chemical inlet 128 of the housing 94. As shown, a second flow valve 172 may be disposed between the heat exchanger 170 and the CO₂-lean chemical inlet 128. In a manner similar to the first flow valve 164, the control system 150 may control operation of the second flow valve 172 to control the flow of the CO₂-lean absorption solvent stream 122 to the stack 90.

The second flow valve 172 may receive output signals 156 from the control system 150 to control a flow of the CO₂-lean absorption solvent stream 122 entering the stack 90. The second flow valve 172 may also transmit input signals 158 indicative of a position of the second flow valve 172 to the control system 150. For example, the control system 150 may open the second flow valve 172 to allow the CO₂-lean absorption solvent stream 122 to flow into the stack 90. The control system 150 may also close the second flow valve 172 to block a flow of the CO₂-lean absorption solvent stream 122 into the stack 90.

As discussed above the CO₂-lean chemical stream 122 and the cooled exhaust gas 74 interact to transfer CO₂ from the cooled exhaust gas 74 to the CO₂-lean chemical stream 122. In certain embodiments, the CO₂-lean chemical inlet 128 directs the CO₂-lean absorption solvent stream 122 into the top 161 of the packing 160. The CO₂-lean absorption solvent stream 122 flows downward, while the cooled exhaust gas 74 flows upward through the stack 90. Accordingly, the CO₂-lean absorption solvent stream 122 and the cooled exhaust gas 74 flow in a countercurrent manner. As CO₂ from the cooled exhaust gas 74 is absorbed into the CO₂-lean absorption solvent stream 122, the CO₂-rich absorption solvent stream 102 is generated. More particularly, the CO₂ may absorb into the liquid of the CO₂-lean absorption solvent stream 122 via mass transfer. The packing 160 may provide additional surface area for the mass transfer to occur. For example, the packing 160 may disrupt, redirect, and/or disperse streams of liquid (e.g., the CO₂-lean absorption solvent stream 122) flowing downward through the packing 160. Then, the cooled exhaust gas 74 may more evenly interact with the CO₂-lean absorption solvent stream 122, thus increasing the efficiency of the absorption process inside the stack 90.

As the CO₂-lean absorption solvent stream 122 absorbs CO₂ from the cooled exhaust gas 74, the CO₂-lean absorption solvent stream 122 removes CO₂ from the cooled exhaust gas 74. The absorption process may be exothermic, thus increasing a temperature of the CO₂-lean absorption solvent stream 122. The heated CO₂-rich absorption solvent stream 102 flows toward the bottom of the housing 94 and exits the stack 90 through the CO₂-rich chemical outlet 104 of the stack 90. The heated CO₂-rich absorption solvent stream 102 may flow toward the heat exchanger 170, where the CO₂-rich absorption solvent stream 102 is further heated by the CO₂-lean absorption solvent stream 122 via heat exchange. In some embodiments, a third flow valve 178 may be disposed between the heat exchanger 170 and the regeneration system 120. The third flow valve 178 may receive output signals 156 from the control system 150 to control a flow of the CO₂-rich absorption solvent stream 102 entering the regeneration system 120. The third flow valve 178 may also transmit input signals 158 indicative of a position of the third flow valve 178 to the control system 150. For example, the control system 150 may open the third flow valve 178 to allow the CO₂-rich absorption solvent stream 102 to flow into the regeneration system 120. The control system 150 may also close the third flow valve 178 to block a flow of the CO₂-rich absorption solvent stream 102 into the regeneration system.

Inside the regeneration system 120, the CO₂ may be removed from the CO₂-rich absorption solvent stream 102 to regenerate the CO₂-lean absorption solvent stream 122 and the CO₂ stream 136, as discussed above. The CO₂-rich absorption solvent stream 102 may be heated before arriving to the regeneration system 120 and/or inside the regeneration system 120. At increased temperatures, the CO₂ may desorb (e.g., release) from the absorption chemical stream, thus regenerating the CO₂-lean absorption solvent stream 122 in a cyclic manner.

While the stack 90 is described as operating via countercurrent flow of the streams, it is to be understood that the streams could flow in a different manner (e.g., co-current flow, cross flow) so long as the absorption solvent may absorb CO₂ from the cooled exhaust gas 74. Additionally, the absorption solvents could be any type of absorption solvent (e.g., monoamines, diamines, triamines, etc.). In certain embodiments, the absorption solvent may have a different heat of absorption (e.g., such as to cause the relative absorption process to be endothermic).

FIG. 3 is a block diagram of an embodiment of a stack 200 having the carbon capture system 96 and the regeneration system 120. Similar to the stack 90, the stack 200 includes the carbon capture system 96 and the packing 160, as discussed above. The stack 200 also utilizes the space inside the hollow stack of certain gas turbine systems to include certain components of a traditional carbon capture plant, such as the exhaust gas processing system 16. The regeneration system 120 of the stack 200 may optionally include additional packing 204 for regeneration of the CO₂-lean absorption solvent. However, it is to be understood that in certain embodiments, other components for regenerating the CO₂-lean absorption solvent and capturing released CO₂ may be included in the regeneration system 120. The stack 200 may house (e.g., contain) both the carbon capture system 96 and the regeneration system 120 within a common housing 201. The common housing 201 may have a divider 206 disposed between the carbon capture system 96 and the regeneration system 120 to separate the carbon capture system 96 and the regeneration system 120. Additional components of the gas turbine system 10, such as the fan 166, the heat exchanger 170, and the flow valves 164, 172, 178, may be located internal or external to the common housing 201 of the stack 202. Further, the common housing 201 may be of any shape (e.g., column, prism, and spheroid) suitable for containing components of both the carbon capture system 96 and the regeneration system 120. In this way, the common housing 201 may enclose (e.g., circumferentially surround) the carbon capture system 96 and the regeneration system 120. Additionally, the common housing 201 may be made of refractory materials suitable for receiving exhaust.

As discussed above, the stack 200 may include the divider 206 (e.g., steel wall, polymer wall) between the carbon capture system 96 and the regeneration system 120 to separate the carbon capture system 96 and the regeneration system 120 so that suitable CO₂ concentration gradients may be established. The divider 206 may be coupled (e.g., welded, bolted) to the inside of the common housing 201. In some embodiments, the divider 206 may have one or more openings to facilitate flows of the CO₂-lean absorption solvent stream 122 and the CO₂-rich absorption solvent stream 102 between the carbon capture system 96 and the regeneration system 120. For example, the openings may permit channels to proceed through certain portions of the divider 206. The channels may be pipes, flow paths, or other means of fluidly connecting the carbon capture system 96 and the regeneration system 120. Control valves or other flow control devices may be placed along the flow path of the CO₂-lean absorption solvent stream 122 and/or the CO₂-rich absorption solvent stream 102 to control their flow.

As described above with reference to FIGS. 1 and 2, the cooled exhaust gas 74 may flow into the carbon capture system 96 through a first inlet 210 of the common housing 201 of the stack 200. The cooled exhaust gas 74 may flow upward though the packing 160 of the carbon capture system 96, flowing countercurrent with the CO₂-lean absorption solvent stream 122, which generally flows in a downward direction through the packing 160. CO₂ may be absorbed from the cooled exhaust gas 74 such that treated exhaust gas 100 (e.g., exhaust gas having a reduced CO₂ content compared to the cooled exhaust gas 74) exits through a first outlet 212 of the stack 200. The CO₂-rich absorption solvent stream 102 may exit from the bottom of the carbon capture system 96, flow through the divider 206, and into the regeneration system 120.

The regeneration system 120 may operate at high temperatures (e.g., temperatures above approximately 100 degrees Celsius). For example, the regeneration system 120 may receive steam 220 from a reboiler 222 fluidly coupled to the stack 200. The reboiler 222 may generate the steam 220 by applying heat to water via heating coils, and direct the steam to the stack 200 via a steam inlet 224. The steam 220 may flow upward through the packing 204 of the regeneration system 120 and contact the CO₂-rich absorption solvent stream 102. The steam 220 transfers heat to the CO₂-rich absorption solvent stream 102, thereby heating the CO₂-rich absorption solvent stream 102. In some embodiments, the heated CO₂-rich absorption solvent stream may desorb (e.g., release) the CO₂ to generate the CO₂-lean absorption solvent stream 122. In some embodiments, the steam 220 recovers the released CO₂ to generate the CO₂ stream 136. The CO₂ stream 136 may exit the stack 200 via a second outlet 226. The CO₂ stream 136 may flow downstream (e.g., in the direction 18) to the CO₂ processing system 140 downstream of the stack 200.

Present embodiments also include a method for treating the exhaust gas using the gas turbine system with an integrated exhaust processing system. FIG. 4 illustrates a flow diagram of a method 400 for treating and recovering CO₂ from the cooled exhaust gas 74. The method 400 includes generating exhaust gas 40 (e.g., high pressure, hot exhaust gas in the gas turbine engine 12 of the gas turbine system 10 (block 402). As discussed above, the hot exhaust gas 40 may be generated by combusting the fuel 32 with oxidants 36, thus generating the exhaust gas 40. The exhaust gas 40 may be used to generate energy via the turbine 22, thus generating the exhaust gas 50 (e.g., low pressure, hot exhaust gas). The exhaust gas 50 may include CO₂. Before releasing the exhaust gas 50 from the gas turbine system 10, the exhaust gas 50 may be processed within the gas turbine system 10 to recover CO₂.

The method 400 also includes cooling the exhaust gas 50 in the cooler 14 while generating steam 82 (block 404). For example, the exhaust gas 50 may be cooled in the HRSG 80. In addition to cooling the exhaust gas 50, the HRSG 80 may generate the steam 82. In certain embodiments, the exhaust gas 50 is further cooled by additional components of the cooler 14, such as the DCC or additional cooling coils, which may be disposed inside the cooler 14 or along the flow path of the exhaust gas 50 either upstream or downstream of the cooler 14. Inside the cooler 14, the exhaust gas 50 may be sufficiently cooled to the temperatures required for efficiently processing the CO₂. In this manner, the cooler 14 generates the cooled exhaust gas 74 from the exhaust gas 50. Additionally, the heat removed from the exhaust gas 50 may be utilized in certain components of the gas turbine system 10, such as the regeneration system 120.

The method 400 also includes receiving the cooled exhaust gas 74 in the stack 90 of the gas turbine system 10 (block 404). The cooled exhaust gas 74 may flow directly from the cooler 14 to the stack 90, without encountering an existing stack without carbon capturing features. Inside the stack 90, a portion of the CO₂ included within the cooled exhaust gas 74 may be absorbed into the CO₂-lean absorption solvent stream 122.

The method 400 further includes treating the cooled exhaust gas 74 within the stack 90 of the gas turbine system 10 to capture CO₂ (block 408). In some embodiments, the cooled exhaust gas 74 may flow into the housing 94 of the stack 90. Inside the housing 94 of the stack 90, the cooled exhaust gas 74 may flow up while the CO₂-lean absorption solvent stream 122 flows down through the housing 94. CO₂ may be absorbed into the CO₂-lean absorption solvent stream 122 from the cooled exhaust gas 74. As described above, the treated exhaust gas 100 may be released from the gas turbine system 10. The CO₂-rich absorption solvent stream 102 may then flow downstream to the regeneration system 120. Inside the regeneration system 120, CO₂ of the CO₂-rich absorption solvent stream 102 may be removed (e.g., desorbed, stripped) from the absorption solvent, and the CO₂-lean absorption solvent stream 122 may be regenerated. In some embodiments, the CO₂ stream 136 may flow from the regeneration system 120 and to the CO₂ processing system 140.

The method 400 additionally includes processing the CO₂ stream 136 within the CO₂ processing system 140 (block 410). For example, the CO₂ processing system 140 may dry and/or compress the CO₂ stream 136 to generate the compressed CO₂ stream 142. In some embodiments, the CO₂ processing system may send the compressed CO₂ stream 142 to end uses, such as oil and natural gas recovery facilities, food and beverage facilities, or sequestration sites for the CO₂.

Technical effects of the presently disclosed systems and techniques include reducing the capital, operational, and maintenance costs of the gas turbine system 10 by integrating the gas turbine system with components of a traditional carbon capture plant, such as the exhaust gas cooling and the carbon capture system. In particular, the integrated power generation and carbon capture plant may include a smaller physical space (e.g., footprint, plot size), fewer components (e.g., only one large stack), and a faster building time as compared to existing power generation and carbon capture plants.

This written description uses examples to disclose the subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A gas turbine system, comprising:
an exhaust gas processing system configured to receive an exhaust gas generated in a gas turbine engine, wherein the exhaust gas processing system comprises:
an exhaust stack having a first inlet and a first outlet, wherein the first inlet is fluidly coupled to a second outlet of a cooler configured to direct the exhaust gas to the exhaust gas processing system via a first conduit extending between the exhaust stack and the cooler, wherein the first conduit comprises a first end configured to be directly coupled to the second outlet of the cooler and a second end configured to be directly coupled to the first inlet of the exhaust stack, and wherein the cooler is configured to receive the exhaust gas from the gas turbine engine; and
a carbon capture system disposed within the exhaust stack and configured to receive a carbon dioxide (CO₂) lean solvent, to remove CO₂ from the exhaust gas, to generate a CO₂-rich solvent comprising the CO₂ removed from the exhaust gas, and to generate a treated exhaust gas.

2. The gas turbine system of claim 1, comprising a regeneration system having a second inlet configured to be directly coupled to the first outlet of the exhaust stack, wherein the regeneration system is configured to receive the CO₂-rich solvent from the carbon capture system, to treat the CO₂-rich solvent, and to generate the CO₂-lean solvent, wherein a second conduit extending between a third outlet of the regeneration system and a third inlet of the exhaust stack is configured to direct the CO₂-lean solvent to the carbon capture system, and wherein a third conduit extending between the first outlet of the exhaust stack and the second inlet of the regeneration system is configured to direct the CO₂-rich solvent to the regeneration system.

3. The gas turbine system of claim 2, comprising a CO₂ processing system disposed downstream from and fluidly coupled to the regeneration system, wherein the CO₂ processing system is configured to receive a CO₂ stream from the regeneration system via a CO₂ conduit extending between the regeneration system and the CO₂ processing system, and wherein the CO₂ stream comprises CO₂ removed from the exhaust gas.

4. The gas turbine system of claim 2, comprising a heat exchanger disposed along the second conduit and configured to heat the CO₂-lean solvent

5. The gas turbine system of claim 2, comprising a reboiler fluidly coupled to the regeneration system, wherein the reboiler is configured to generate steam and direct the steam to the regeneration system.

6. The gas turbine system of claim 1, comprising a regeneration system disposed within the exhaust stack, wherein the regeneration system is fluidly coupled to the carbon capture system and is configured to receive the CO₂-rich solvent from the carbon capture system, to treat the CO₂-rich solvent, and to generate the CO₂-lean solvent, wherein a second conduit extending between the regeneration system and the carbon capture system is configured to direct the CO₂-lean solvent to the carbon capture system.

7. The gas turbine system of claim 6, comprising a CO₂ processing system disposed downstream from and fluidly coupled to the regeneration system, wherein the CO₂ processing system is configured to receive a CO₂ stream from the regeneration system via a CO₂ conduit extending between the regeneration system and the CO₂ processing system, and wherein the CO₂ stream comprises CO₂ removed from the exhaust gas.

8. The gas turbine system of claim 1, comprising a control system programmed to control one or more components of the gas turbine system, wherein the control system comprises instructions disposed on a non-transitory, machine readable medium programmed to: control the combustion of a fuel in the gas turbine engine to generate the exhaust gas; and
control treatment of the exhaust gas to produce the treated exhaust gas within the exhaust stack.

9. The gas turbine system of claim 1, comprising a valve disposed along the first conduit, wherein the valve is configured to control a flow of the exhaust gas from the cooler to the exhaust gas processing system.

10. The gas turbine system of claim 1, wherein the cooler comprises cooling coils configured to cool the exhaust gas.

11. The gas turbine system of claim 1, wherein the cooler is a heat recovery steam generator (HRSG).

12. The gas turbine system of claim 1, wherein the cooler is a direct contact cooler.

13. The gas turbine system of claim 1, comprising a fan disposed along the first conduit, wherein the fan is configured to increase a pressure of the exhaust gas flowing into the first inlet of the exhaust stack.

14. A gas turbine system, comprising:
a gas turbine engine configured to generate and exhaust gas;
a cooler disposed downstream from the gas turbine engine and comprising a first inlet and a first outlet, wherein the first inlet is configured to receive the exhaust gas from the gas turbine engine; and
an exhaust gas processing system fluidly coupled to the cooler, wherein the exhaust gas processing system comprises:
an exhaust stack having a second inlet and a second outlet, wherein the second inlet is fluidly coupled to the first outlet of the cooler via a first conduit extending between the exhaust stack and the cooler and configured to direct the exhaust gas from the cooler to the exhaust stack, and wherein the first conduit comprises a first end configured to be directly coupled to the first outlet of the cooler and a second end configured to be directly coupled to the second inlet of the exhaust stack; and
a carbon capture system disposed within the exhaust stack and configured to receive a carbon dioxide (CO₂) lean solvent, to remove CO₂ from the exhaust gas, to generate a CO₂-rich solvent comprising the CO₂ removed from the exhaust gas, and to generate a treated exhaust gas.

15. The gas turbine system of claim 14, comprising a regeneration system having a third inlet configured to be directly coupled to the second outlet of the exhaust stack, wherein the regeneration system is configured to receive the CO₂-rich solvent from the carbon capture system, to treat the CO₂-rich solvent, and to generate the CO₂-lean solvent, wherein a second conduit extending between a third outlet of the regeneration system and a fourth inlet of the exhaust stack is configured to direct the CO₂-lean solvent to the carbon capture system, and wherein a third conduit extending between the second outlet of the exhaust stack and the third inlet of the regeneration system is configured to direct the CO₂-rich solvent to the regeneration system.

16. The gas turbine system of claim 14, comprising a regeneration system disposed within the exhaust stack, wherein the regeneration system is fluidly coupled to the carbon capture system and is configured to receive the CO₂-rich solvent from the carbon capture system, to treat the CO₂-rich solvent, and to generate the CO₂-lean solvent, wherein a second conduit extending between the regeneration system and the carbon capture system is configured to direct the CO₂-lean solvent to the carbon capture system.

17. The gas turbine system of claim 14, wherein the cooler is a heat recovery steam generator (HRSG).

18. The gas turbine system of claim 14, wherein the cooler is a direct contact cooler

19. The gas turbine system of claim 14, comprising a control system programmed to control one or more components of the gas turbine system, wherein the control system comprises instructions disposed on a non-transitory, machine readable medium programmed to:
control the combustion of a fuel in the gas turbine engine to generate the exhaust gas; and
control treatment of the exhaust gas to produce the treated exhaust gas within the exhaust stack.

20. A method, comprising:
generating an exhaust gas in a gas turbine engine disposed within a gas turbine system;
directing the exhaust gas to a cooler fluidly coupled to the gas turbine engine to generate a cooled exhaust gas;
supplying the cooled exhaust gas from the cooler to an exhaust gas processing system via a conduit having a first end and a second end, wherein the first end is configured to be directly coupled to an outlet of the cooler and the second end is configured to be directly coupled to an inlet of the exhaust gas processing system, wherein the exhaust gas processing system comprises a carbon capture system disposed within an exhaust stack of the gas turbine system;
removing carbon dioxide (CO₂) from the exhaust gas within the carbon capture system to generate a treated exhaust gas and a CO₂-rich solvent; and
treating the CO₂-rich solvent in a regeneration system fluidly coupled to the carbon capture system to recover CO₂ from the CO₂-rich solvent and to generate a CO₂-lean solvent, wherein the regeneration system is configured to supply the CO₂-lean solvent to the carbon capture system.
